(19) United States
(12) Patent Application Publication
(10) Pub. No.: US 2018/0044535 A1
(43) Pub. Date: Feb. 15, 2018

(54) THREE-LAYERED NANOCOMPOSITE WITH IMPROVED THERMAL AND HEAT PROPERTIES AND PRODUCTION THEREOF

(71) Applicant: ISTANBUL TEKNIK UNIVERSITESI REKTORLUGU, Istanbul (TR)

(72) Inventors: A. Sezai SARAC, Istanbul (TR); Eyup Sabri KAYALI, Istanbul (TR); Fatma Zehra ENGIN SAGIRLI, Istanbul (TR)

(73) Assignee: ISTANBUL TEKNIK UNIVERSITESI REKTORLUGU, Istanbul (TR)

(21) Appl. No.: 15/554,715

(22) PCT Filed: Sep. 19, 2016
(86) PCT No.: PCT/TR2016/050348

§ 371 Date: Aug. 31, 2017

(30) Foreign Application Priority Data
Sep. 30, 2015 (TR) 2015/12014

(51) Int. Cl. C09D 5/00; C09D 4/00; H01B 5/14; C04B 41/89; C09D 5/02; C09D 165/00; C09D 5/24; C09D 113/02

(52) U.S. Cl. CPC C09D 5/00; C09D 5/24; C09D 4/00; C09D 113/02; C04B 41/89; C09D 5/022; C09D 165/00; H01B 5/14; C04B 2235/3236

(57) ABSTRACT

The invention is related to three-layered nanocomposites which are created by encapsulating a ceramic particle in latex as “coreshell” and coating a conductive polymer on this structure.

### CROSS REFERENCE TO RELATED APPLICATIONS

This application is the national phase of International Application No. PCT/TR2016/050348, filed on Sep. 19, 2016, which is based upon and claims priority to Turkish Patent Application No. 2015/12014, filed on Sep. 30, 2015, the entire contents of which are incorporated herein by reference.

### FIELD OF THE INVENTION

The invention is related to three-layered nanocomposites which are created by encapsulating a ceramic particle in latex as “coreshell” and coating a conductive polymer on this structure.

### BACKGROUND OF THE INVENTION

Polymer nanocomposites have a wide range of application due to their improved electrochemical, mechanical and magnetic properties. Among the polymer nanocomposites, conductive polymer nanocomposites have a substantial importance. These are generally divided into two types. While the first one is adding conductive nanofillers into a non-conducting polymer, the second one is the use of conductive polymer as the matrix. Integrating nanoparticles into the polymers improves the properties of polymers such as thermal stability, magnetic properties and dielectric coefficient.

Barium titanate (BaTiO₃) which is one of the transition metal oxides has properties such as ferroelectricity, piezoelectricity and high dielectric coefficient and is used for improving dielectric properties of the polymers.

In the methods used in the known state of the art, since there is no latex to carry the particle, most of the particle has been precipitated in the solution and left as waste. This caused the efficiency, electrical and thermal functional properties of the obtained structures to decrease. In the studies conducted until today for textile structures, particle and polymer blends are used.

When inventions similar to said invention are examined, these documents are found:
ZhangXi et al,“Magnetoresistive Conductive Polyaniline-Barium Titanate Nanocomposites with Negative Permitivity”: Nanocomposites that contain barium titanate are described. The polymer used in the document is polyaniline.
Yong Li et al, “Large Dielectric Constant and High Thermal Conductivity in Poly(vinylidenefluoride)/BariumTitanate/Silicon Carbide Three-Phase Nanocomposites”: In this document, a three-phase composite that contains poly(vinylidenefluoride) (PVDF), barium titanate (BT) and β-silicon carbide (β-SiC) is described.
CN102382322 (A): In this patent document, polystyrene/barium titanate microsphere composites that have “coreshell structure” are described. In production of the invention subject matter of said document, emulsion polymerization and hydrothermal synthesis method are combined and factors such as surfactant, solvent and ambient temperature can be controlled in the process.
CN101944434 (A): In the invention of this patent document, a polymer composite embedded in a microcapacitor and its preparation method is described. In this invention barium titanate nanoparticles are used and polyimide/barium titanate composite material is prepared by in situ polymerization. By this method, a dense dielectric film with a homogenous and large area is obtained and the product subject matter of said invention is a 2-phase structure.

### SUMMARY OF THE INVENTION

Present invention describes a three-layered structure obtained by enclosing barium titanate with latex which is a non-conductive matrix and then coating it with a conductive polymer. Unlike enclosing barium titanate with only a non-conductive matrix, coating it with a conductive polymer as the third layer improves the properties of this structure such as thermal and electrical conductivity and capacitive and shielding. In addition to abovementioned properties, since mechanical properties of the composites obtained in the presence of polymer matrix and conductive polymer are improved, their properties such as warping, coating or use in the film form are improved as well. Thus, when the nanocomposite of the invention is coated on to textile or similar structures, it will improve workability of them without substantially modifying their mechanical properties.

In said invention, in situ emulsion polymerization method is used to create the three-layered coreshell structure. Since this method is a controlled method, the obtained structure is homogenous and particle size can be controlled via time. Besides, the three-layered structure of the invention can be created at once.

As a result, the novelty provided by this study for the two and three phase structures in the general literature is that; through the advantage of the emulsion system that enables obtaining a structure with homogenous distribution by respectively and in a controlled manner coating first latex and then conductive polymer onto the barium titanate and that provides an environmentalist approach depending on not using an organic solvent, a nanohybrid structure that has new different properties is created by integrating three phases as a result of chemical interaction of the materials. Moreover, it will be the most important novelty of this structure that it will enable development of new materials for use in textile industry, sensor, biomaterials and electronics industries as the final product in the form of fibres and coatings due to its mechanical, electrical, electrochemical and thermal properties.

### BRIEF DESCRIPTION OF THE DRAWINGS

FIG. 1: Three-layered nanocomposite with improved thermal and heat properties.

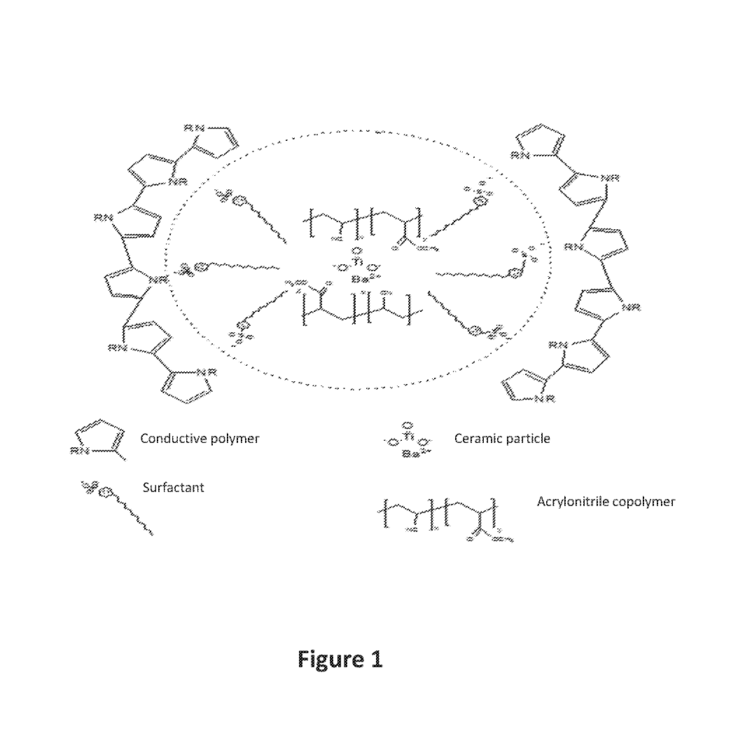

FIG. 2: Particle size distribution of three-layered nanocomposite structure

FIG. 3: FTIR spectroscopy results of nanocomposites

FIG. 4: XRD results of nanocomposites

FIG. 5: a) SEM b) TEM and c) AFM results of three-layered structure

FIG. 6: Bode Phase and bode magnitude graphs of nanocomposites

### DETAILED DESCRIPTION OF THE INVENTION

The differences of the present invention from the similar documents mentioned in the known state of the art are as follows:
During the emulsion polymerization since they are separated due to surfactant (surface active agent) and since first latex and then conductive polymer is coated around the barium titanate which is suspended in aqueous media (without using any organic solvent), each barium titanate particle is homogenously coated by the two layers. PDI values are ˜0,05 and this proves that particle growth is rendered homogenously and in a controlled manner.
Due to “coreshell” structure, since it is enabled that ions and electrons that provide electrical and thermal conductivity can regularly jump and move in the homogenous structure, conductance properties are considerably good.
Moreover, electrochemical behaviours of the structures are capacitive since conductive polymer is coated on latex. Furthermore, it is possible to use them as shielding material depending on the selected frequency range.
By adding latex layer in between and adding conductive polymer layer on it instead of directly coating conductive polymer on the particle, controlled coating and growth is ensured and also warping, film exfoliation and coating properties are improved due to improvement in mechanical properties.

In the system used for the invention, by in situ processing in one-step, it is both ensured that the particle better hangs on to the structure by moving and the polymer is homogenously distributed onto the surface. Moreover, since the flexibility, workability and according to obtained results mobility of the structure in the solution have increased due to used latex, its electrical conductivity is increased as well. Obtaining nanocomposite in this way and transforming it to textile surfaces is an innovational approach. Furthermore, it is an environmentalist approach to use aqueous media and ambient temperature in the conducted studies.

### Creating Three-layered Nanocomposite:

In this invention, acrylonitrile copolymer is coated around the barium titanate particle by in situ emulsion polymerization method. By coating a conductive polymer on this established “coreshell” structure, the three-layered structure is successfully created. Said structure is created because of introduction of monomer molecules between the swelled plates and polymerization. During in-situ polymerization, monomer molecules settle between the layers by polarity effect and polymerization occurs. Polymerization is started by the heat of the reaction. Thus, first, surfactant-water solution is prepared and while this solution is vigorously stirred ceramic particles at different rates are added into the structure. After stirring this solution for a certain amount of time, another monomer that will form the acrylonitrile (AN) and the copolymer is added into the structure. All the monomers that can form acrylonitrile and copolymer are suitable for this system. The structure is kept in ultrasonic mixer in order to form the micro emulsion. Then the initiator (precursor) is added to the structure and the ceramic particle is coated on the core by polymerization of the latex shell. After the polymerization, conductive monomers are added into the structure and conductive polymer is coated onto the latex coated ceramic particle. Conductive polymers such as pyrrole, aniline and thiophene are suitable for this system.

In the process of establishing the three-layered structure, the ratio of the nanoparticle, monomers and conductive polymer monomer are specified depending on the surfactant ratio. In said system, it is defined as 1:4-1:4 and 2:1 (mole/mole).

In this invention, the surfactants that are used as carrier also have the dopant duty besides their carrier duty. In the conducted studies, it is seen that type of the surfactant material is effective in carrying and doping the particle and depending on this efficiency and conductivity values as well as particle size and micro structures are also changed.

### Conducted Analysis and Results:

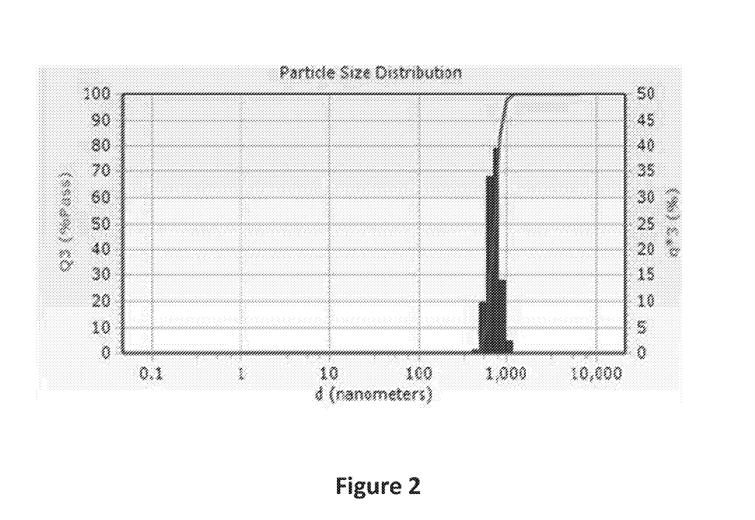

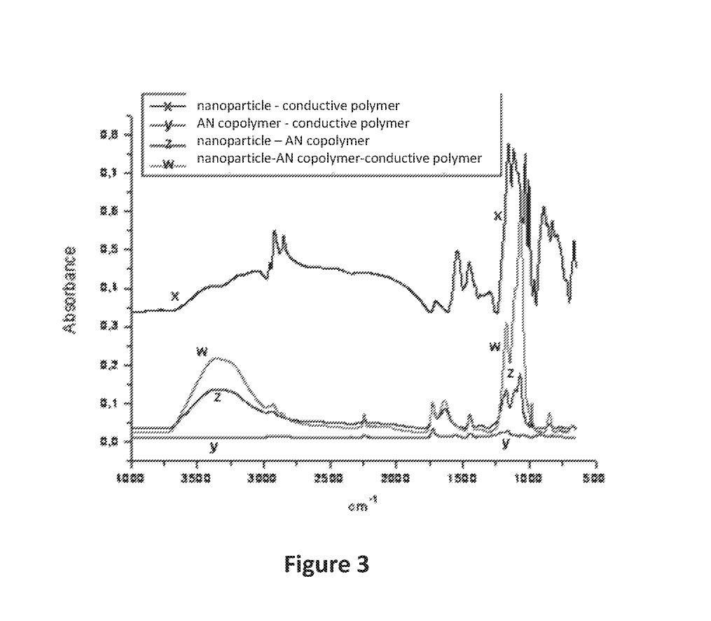

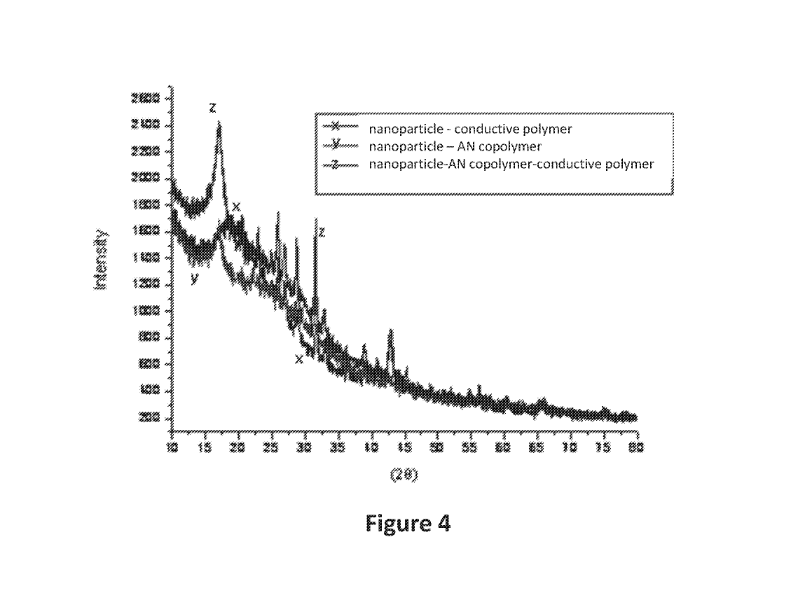

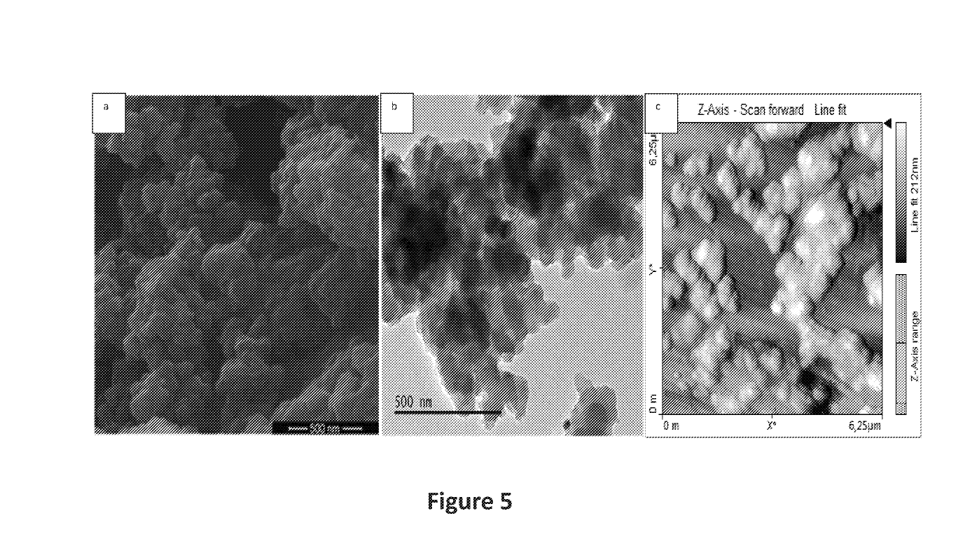

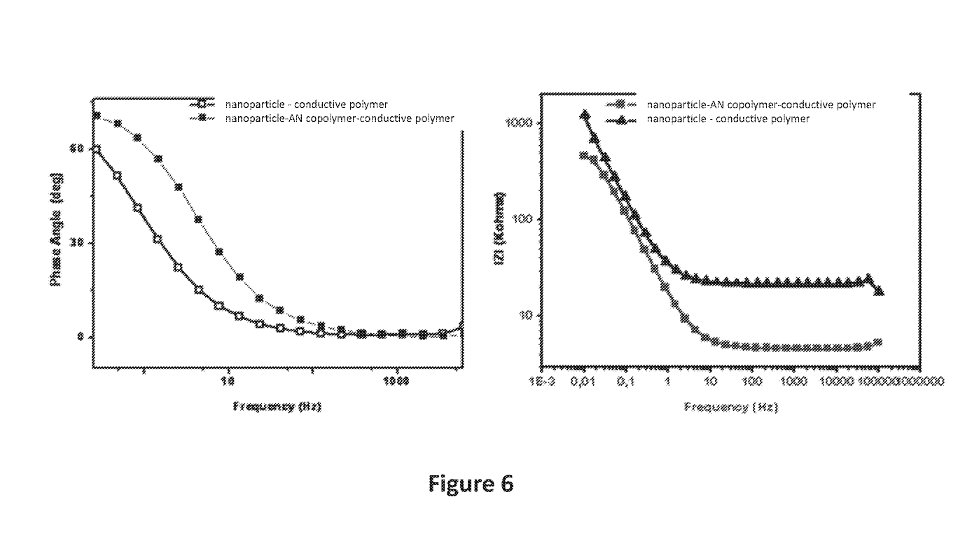

As a result of conducted analysis, it is seen that the three-layered structure is successfully created by the method of the invention. It is seen that particle size distributions are homogenous via particle size distribution value which is approximately 0,05 (FIG. 2). In other words, approximately 100% of the particles have the same size. In FTIR analysis results (FIG. 3), results of the latex coating and conductive polymer coating around the particle and the results of the three-layered structure can be seen top to bottom. As can be understood by the peaks on the analysis graph, the peaks obtained as a result of interaction of three structures in the nanocomposite show that a new structure is obtained and the nanoparticle is coated by the latex and the conductive polymer. When XRD graphs (FIG. 4) are examined, it is seen that nanoparticle peak amplitudes decrease when in three-layered structure. This attenuation in the peaks shows that detection of X-rays scattered by the inorganic particle due to polymer chains growing on the nanoparticle surface are prevented, in other words the surrounding of the particle is coated by an organic structure. Establishment of the three-layered structure, the layers, surface roughness and homogeneity of distribution on the surface are investigated by SEM, TEM and AFM analysis (FIG. 5). Additionally, when this analysis results are examined, it is seen that the structure is completely coated. By the conducted DC conductivity measurements (Table 1), when compared to other structures, it is seen that a more conductive structure is obtained by the three-layered structure. Besides, capacitive and magnetic properties of the structure are examined by using electrochemical impedance spectroscopy results (FIG. 6) and it is seen that a conductive, capacitive and shielding material is created by the three-layered structure.

TABLE 1
Conductivity and particle size values

| | Nanoparticle- | AN copolymer- | Nanoparticle-AN |
|---|---|---|---|
| | conductive | conductive | copolymer-conductive |
| | polymer | polymer | polymer |
| Conductivity | 69.83 | 143.15 | 154.38 |
| (μS) | | | |
| Particle Size | 117.16 | 69 | 704 |
| (nm) | | | |

1. A production method of a three-layered nanocomposite with improved thermal and heat properties comprising the steps of:
preparing surfactant-water solution,
while vigorously stirring the surfactant-water solution, adding ceramic particles at different rates into a structure forming acrylonitrile and copolymer,
after stirring the surfactant-water solution for a certain amount of time, adding another monomer into the structure,
leaving the structure in ultrasonic mixer in order to form a micro emulsion,
adding an initiator into the structure,
coating a latex shell on a ceramic particle core by polymerization and establishing a core-shell structure, and
by adding conductive monomers into the core-shell structure established after polymerization, coating conductive polymer onto the latex coated ceramic particle.

2. The production method of a three-layered nanocomposite with improved thermal and heat properties according to claim 1, wherein all the monomers form copolymer with acrylonitrile, and all the monomers are suitable for a system.

3. The production method of a three-layered nanocomposite with improved thermal and heat properties according to claim 1, wherein the ceramic particle is barium titanate particle.

4. The production method of a three-layered nanocomposite with improved thermal and heat properties according to claim 1, wherein the conductive polymer is selected from the group consisting of pyrrole, aniline, and thiophene.

5. The production method of a three-layered nanocomposite with improved thermal and heat properties according to claim 1, wherein ratios of nanoparticle, monomers and conductive polymer monomer are defined depending on the ratio of the surfactant.

6. The production method of a three-layered nanocomposite with improved thermal and heat properties according to claim 4, wherein a ratio of BaTiO₃/surfactant and a ratio of conductive monomer/surfactant are 1:4 mole/mole.

7. The production method of a three-layered nanocomposite with improved thermal and heat properties according to claim 1, wherein in situ emulsion polymerization is initiated by heat of reaction.

8. The production method of a three-layered nanocomposite with improved thermal and heat properties according to claim 7, wherein a reaction temperature is 70° C. while coating latex on nanoparticle and then at ambient temperature while coating conductive polymer on the latex.

9. The production method of a three-layered nanocomposite with improved thermal and heat properties according to claim 7, wherein a hardener is not used in a system.

10. The production method of a three-layered nanocomposite with improved thermal and heat properties according to claim 7, wherein a catalyst is not used in a system.

11. A three-layered nanocomposite produced by the following steps:
preparing surfactant-water solution,
while vigorously stirring the surfactant-water solution, adding ceramic particles at different rates into a structure forming acrylonitrile and copolymer,
after stirring the surfactant-water solution for a certain amount of time, adding another monomer into the structure,
leaving the structure in ultrasonic mixer in order to form a micro emulsion,
adding an initiator into the structure,
coating a latex shell on a ceramic particle core by polymerization and establishing a core-shell structure, and
by adding conductive monomers into the core-shell structure established after polymerization, coating conductive polymer onto the latex coated ceramic particle.

12. The three-layered nanocomposite according to claim 11, wherein a particle size is approximately 700 nm.

13. The three-layered nanocomposite according to claim 11, wherein the nanocomposite is a conductive structure.

14. The three-layered nanocomposite according to claim 11, wherein the nanocomposite has capacitive properties in a frequency range of 0.16 Hz-0.85 Hz.

15. The three-layered nanocomposite according to claim 11, wherein the nanocomposite is a material with shielding properties.
